(19) United States
(12) Patent Application Publication
(10) Pub. No.: US 2005/0015800 A1
(43) Pub. Date: Jan. 20, 2005

(54) Method and system for managing television advertising

(76) Inventor: Thomas J. Holcomb, Snohomish, WA (US)

Correspondence Address: BLACK LOWE & GRAHAM, PLLC, 701 FIFTH AVENUE, SUITE 4800, SEATTLE, WA, 98104, US

(21) Appl. No.: 10/622,676

(22) Filed: Jul. 17, 2003

(51) Int. Cl. H04N 7/025; G06F 17/60; H04N 7/10; G06F 3/00; H04N 5/445; G06F 13/00

(52) U.S. Cl. 725/35; 705/27; 725/32; 725/42; 725/34; 725/46

(57) ABSTRACT

Methods, a computer-readable medium, and a system are provided for managing television advertising inventory and pricing in a service area. Available advertising information is classified into a matrix including a plurality of cells. Each of the cells is associated with a channel, a daypart, and a service zone within the service area. An advertising inventory is associated with each cell. Relevant viewer information is associated with each cell. An advertising price settable based on the available advertising inventory and the relevant viewer information also is associated with each cell. Available advertising inventory information and the pricing information stored in the matrix is accessible by specifying at least one selection criterion reflective of the advertising information stored in the plurality of cells.

### FIELD OF THE INVENTION

This invention relates generally to television advertising and, more specifically, to managing inventory and pricing of television advertising.

### BACKGROUND OF THE INVENTION

Only a few decades ago, managing television advertising was a relatively simple process. Into the 1970s, even good-sized television markets generally had six or fewer television stations. Typically, three of those stations were affiliated with one of the three commercial broadcast networks, the American Broadcasting Company (“ABC”), the Columbia Broadcast System (“CBS”), and the National Broadcasting Company (“NBC”). In addition, many cities also had a Public Broadcasting Service (“PBS”) station. Some cities also had one or two commercial stations independent of the networks. These stations typically broadcast on ultra-high frequency (“UHF”) bands, and thus had relatively little broadcast range and relatively poor broadcast quality as compared to the other commercial stations that broadcast on very high frequency (“VHF”) bands. Such a handful of stations constituted the entirety of a typical television market.

Managing advertising in such an environment was relatively easy because of the confined market. In a hypothetical six-station television market with three network affiliates, one public television station, and two independent stations as described above, advertising choices were relatively simple for would-be local advertisers. Of the six television stations, PBS stations do not accept paid advertising, thus, only five choices were left. It was not an exhaustive matter for advertisers to contact each of those five stations and obtain a “rate card” specifying what advertising time cost during different dayparts, ranging from early morning through the end of broadcasting that night. Based on the prices, the advertisers then could decide whether to spend their advertising dollars on the pricier network affiliates or the cheaper independent stations, and whether to splurge for evening “primetime” which attracted larger audiences, or opt for less expensive commercials at other times of day.

For the commercial television stations, managing available advertising time also was a relatively simple matter. For the network affiliates, much of their advertising time already was dictated by the networks which sold advertising time to national advertisers. With the limited advertising time available, it was a relatively simple matter to keep a notebook or ledger of the time that either had been sold or was available for sale.

As far as pricing the available time, the stations could perform a simple supply and demand analysis of the advertising time on-hand. Ratings services, such as those provided by A.C. Nielsen, tracked what proportions of households watched what programs on what networks. As a result of the popularity of their networks' programs, affiliates could assess demand for advertising time and, thus, determine what prices to charge. Would-be advertisers could look at the ratings and make their own determination as to whether the prices quoted were worthwhile. In sum, the advertising market was a really simple one to manage.

Certainly, television has changed dramatically over the last thirty years. The inception and proliferation of cable television opened a floodgate of alternative programming. Instead of watching free television, households paid for television subscriptions. Local television service providers in turn paid part of the subscription fees to each of the channels they carried for their subscribers. The possibility of an income stream in addition to advertising revenue made possible the advent of dozens and dozens of networks. Replacing the few major broadcast services attempting to provide programming appealing to everyone, specialty networks were formed to cater to myriad specific interests. A typical household today receives channels devoted solely to science, science fiction, history, biographies, cooking, home improvement, and other topics, to say nothing of multiple channels devoted exclusively to sports, news, and other forms of entertainment.

As much as television viewing has changed over this period, television advertising may have changed even more. As in the era dominated by a few broadcast networks, advertising on most channels includes a great deal of national advertisers. However, the remainder of the advertising is managed not by a few local stations, but by local pay television providers. Local cable television providers or local distributors of satellite television manage the advertising inventory and pricing for dozens and dozens of stations that broadcast around the clock. The era in which local network affiliates could manage their advertising inventory with a notebook or a ledger is over.

Complicating matters, most of these pay television providers service a large area covering a number of service zones. Typically, the service zones represent geographical subsets of the service area. FIG. 1 shows an area 100 serviced by a pay television provider which includes a number of service zones. The service zones may be divided by geographical boundaries such as streams and hills or major streets. If the area 100 is, for example, a city, Zone E 110 might represent the inner city. Zone B 120, Zone D 130, Zone F 140, Zone G 150, and Zone C 160 might represent neighborhoods of differing characters. The populations of these zones 110-160 might vary in terms of median age. For example, while Zone F 140 might be dominated by retirees, Zone C 160 might be dominated by families with young children. Each of these zones 110-160 might be predominated by households having a household income vastly different from other zones in the service area 100. It is also possible that the personality of each of these zones 110-160 might vary greatly. One zone might feature an active nightlife and, thus, attract persons who drive expensive cars or spend a lot of money dining out. At another extreme, a zone such as Zone A 170 might be a relatively distant, quiet suburb where cooking, gardening and other hobbies are more of an attraction.

Information about potential viewers in zones 110-170 includes both demographic information and psychographic information. Demographic information, such as age, gender, and similar immutable factors has long been available to inform marketing and advertising efforts. More recently, psychographic information, such as spending habits and viewer preferences has been made available to both sellers and buyers of advertising. A pay television provider servicing an area 100 having diverse zones 110-170 likely would want to manage its advertising in light of these factors. However, attempting to correlate such information with channels, dayparts, and zones certainly would overwhelm a simple tracking system.

Thus, there is an unmet need in the art for effective methods for television service providers to manage advertising inventory and pricing.

### SUMMARY OF THE INVENTION

Embodiments of the present invention provide methods, a computer-readable medium, and a system for effective management of television advertising. The methods, computer-readable medium, and system of the present invention allow pay television service providers to evaluate their advertising inventories by channels, dayparts, and zones. Moreover, embodiments of the present invention allow television service providers to assess demographic and psychographic information. As a result, television service providers can more effectively set advertising prices based on supply and demand or the desirability of the specific market as reflected by viewer information.

More specifically, various embodiments of the present invention provide methods, a computer-readable medium, and a system for managing television advertising inventory and pricing in a service area. Available advertising information is classified into a matrix including a plurality of cells. Each of the cells is associated with a channel, a daypart, and a service zone within the service area. An advertising inventory is associated with each cell. Relevant viewer information is associated with each cell. An advertising price settable based on the available advertising inventory and the relevant viewer information also is associated with each cell. Available advertising inventory information and the pricing information stored in the matrix is accessible by specifying at least one selection criterion reflective of the advertising information stored in the plurality of cells.

In accordance with further aspects of the invention, the service zones associated with the cells may be delineated geographically or according to other information aligning persons into identifiable groups. Cells of the matrix are populated with viewer information regarding potential television viewers in the service zones associated with the cells. The viewer information is gathered from surveys of the potential television viewers in the services zones or extracted from set-top boxes configured to relay television content from a television service provider in the service zones. Psychographic information, including information about viewer income, viewer spending preferences, viewer interests, viewer politics, and viewer television viewing habits is associated with the cells. In addition, the viewer information associated with the cells includes demographic information including information such as viewer age, viewer gender, and viewer residence information.

In accordance with other preferred aspects of the invention, the available advertising inventory includes specific timing and duration information regarding when available advertising inventory exists. The available advertising inventory is updateable in real-time to reflect sales of advertising slots. Moreover, the pricing of the inventory is automatically adjustable the pricing information as a function of the available advertising inventory.

In accordance with still further preferred aspects of the invention, the advertising inventory and pricing information is accessible by specifying at least one of the channel, the daypart, and the service zone of interest. The advertising inventory and pricing information also is accessible by specifying at least one of availability, unit price, demographic information, and psychographic information. The information accessed can be sorted according to at least one of the availability, the unit price, the demographic information, and the psychographic information to access a relative view of the inventory and pricing information.

In accordance with a further aspect of the present invention, shared access to the matrix is accessible to a plurality of users to provide them with current advertising inventory and pricing information.

### BRIEF DESCRIPTION OF THE DRAWINGS

The preferred and alternative embodiments of the present invention are described in detail below with reference to the following drawings.

FIG. 1 is a map of a conventional coverage area served by a local pay television provider;

FIG. 2 is a three-dimensional view of a matrix used in the present invention;

FIG. 3 is a two-dimensional slice of the matrix of FIG. 2;

FIG. 4 is shows data stored in a cell of the matrix of FIG. 2;

FIG. 5 is an access screen from an interface for accessing the matrix of FIG. 2;

FIG. 6 is an inventory and price screen for a selection made from an option screen as shown in FIG. 5;

FIG. 7 is a flowchart of a routine according to an embodiment of the present invention for monitoring advertising inventory changes and adjusting pricing;

FIG. 8 is an inventory sort screen;

FIG. 9 is a flowchart of a routine according to an embodiment of the present invention;

FIG. 10 is a system diagram of a multiple-user environment of the present invention; and

FIG. 11 is a computer system operable to support operation of a software embodiment of the present invention.

### DETAILED DESCRIPTION OF THE INVENTION

By way of overview, embodiments of the present invention provide methods, a computer-readable medium, and a system for managing television advertising inventory and pricing in a service area. Available advertising information is classified into a matrix including a plurality of cells. Each of the cells is associated with a channel, a daypart, and a service zone within the service area. An advertising inventory is associated with each cell. Relevant viewer information is associated with each cell. An advertising price settable based on the available advertising inventory and the relevant viewer information also is associated with each cell. Available advertising inventory information and the pricing information stored in the matrix is accessible by specifying at least one selection criterion reflective of the advertising information stored in the plurality of cells.

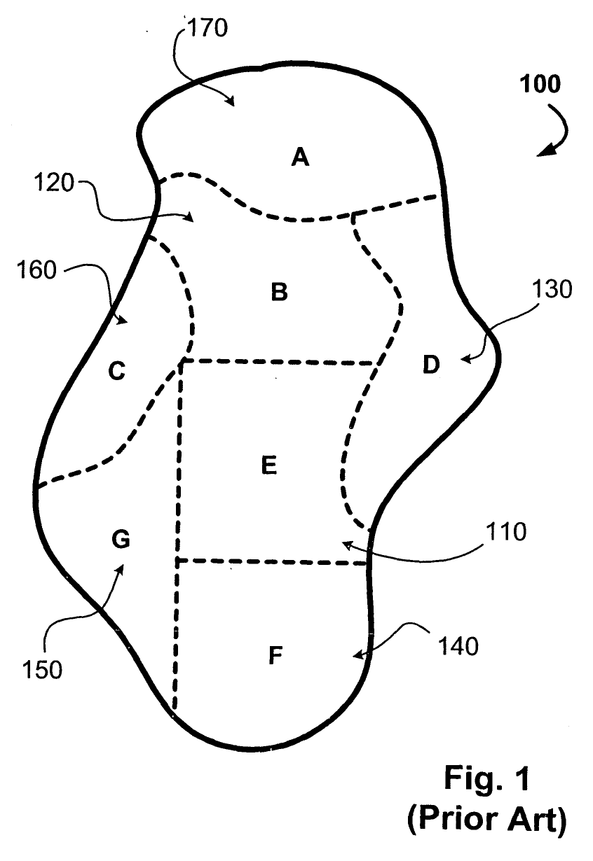

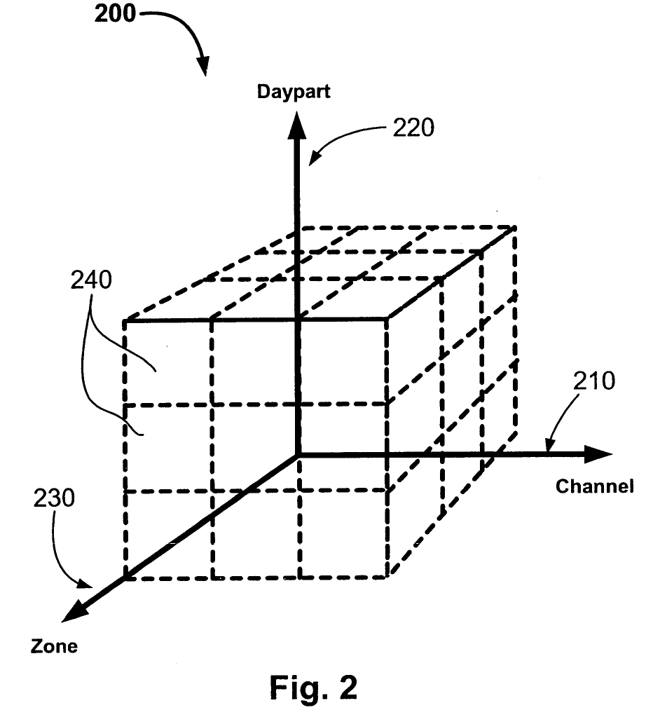

FIG. 2 shows a matrix 200 used by embodiments of the present invention to track advertising inventory and pricing information. Logically, the matrix 200 has three dimensions and, therefore, three axes: channel 210, daypart 220, and zone 230. Associated with each set of coordinates in this three-space is a cell 240 which stores advertising information related to the various combinations of channel 210, daypart 220, and zone 230. Using the matrix 200, persons managing advertising can consider the marketability of advertising during a particular program—which airs on a particular channel 210 at a particular daypart 220—in various zones 230. Alternatively, those persons managing advertising interested in reaching viewers in a particular zone 230 can consider how different channels 210 and dayparts 220 reach those zones 230. The three-dimensional matrix 200 allows for great flexibility in analyzing the framework of advertising in an area 100 (FIG. 1) served by a television service provider.

As previously described, these zones typically include geographical zones with a television service provider's service area 200. However, the zones 230 could represent a different subset of the service area. For example, one zone 230 might include those households subscribing to a service package reflecting a certain range of interests. The service package could include, for example, a number of channels focusing on outdoor activities or a number of channels focusing on financial information. A television service provider might wish to align households with one or more viewers having an in-depth interest in such a topic into zones 230, instead of relying on geographically-based zones 230 as shown in FIG. 1. Without regard to how the zones 230 may be aligned embodiments of the invention can be used to manage advertising inventory and pricing in the zones 230.

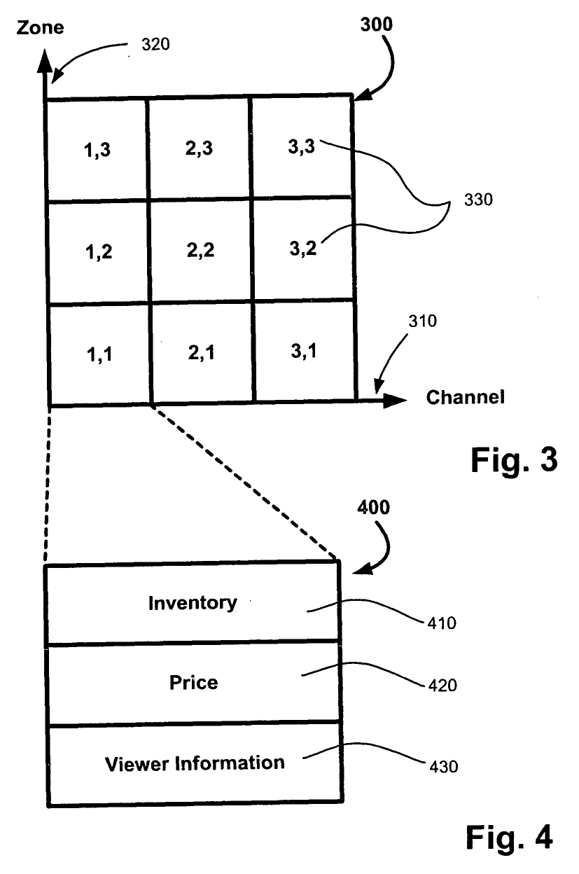

FIG. 3 shows a two-dimensional slice 300 of the matrix 200 (FIG. 2). The slice 300 of the matrix 200 (FIG. 2) is taken at a particular daypart, and allows a person evaluating television advertising to consider how different channels 310 reach potential viewers in different zones 320. Each cell slice 330 stores information reflecting how each channel reaches viewers in each zone 320. Thus, for example, the program airing at the daypart represented by the cell slice 330 at channel 1, zone 1 (1,1) compares with the program airing at the daypart represented by the cell slice at channel 3, zone 3 (3,3). Thus, one can determine which channel 310 reaches viewers in which zone 330. Similarly, one can consider a particular zone 320 and compare how the different channels 310 reach viewers during different dayparts 220 (FIG. 2), or can consider a particular channel 310 and compare how different dayparts 220 (FIG. 2) might reach viewers in different zones 320. The ability to evaluate advertising information classified in these three major categories allows great flexibility in evaluating advertising information.

Embodiments of the present invention not only provide flexibility in evaluating advertising information in cells 240 (FIG. 2) related to different channels, dayparts, and zones, but associate a wide variety of information with each cell 240 (FIG. 2). FIG. 4 represents data 400 that might be stored in a cell 240 stored in the matrix 200. The data 400 includes three general types of information: advertising inventory 410, price 420, and viewer information 430. Advertising inventory 410 signifies the availability of advertising time at the channel, daypart, and zone. Using the advertising inventory 410 and the price 420 of that advertising inventory 410 allows a user of the matrix 200 (FIG. 2) to perform a supply-demand analysis of whether the available advertising time is appropriately priced. If the advertising inventory 410 is high and the price 420 is high, a person responsible for pricing that advertising time might consider reducing the price 420 to better market that unused advertising time. Alternatively, if the inventory 410 is low or sold out, the price 420 might be set too low, and the provider might be able to improve its profit margin by increasing the price 420.

Furthermore, the data 400 also allows a user of the matrix 200 (FIG. 2) to consider additional data in the form of viewer information 430 associated with that cell in making managing and pricing available television advertising time. The viewer information can include demographic information, such as age and gender of typical viewers associated with the channel, daypart, and zone the cell describes. The viewer information also can include psychographic information, such as viewer income, viewer spending preferences, viewer interests, viewer politics, and viewer television viewing habits which give more specific information about viewers who watch that channel at that time in that zone. Considering this information, the cell 240 (FIG. 2) might represent a program airing in a zone where the program will be watched by mature, high income individuals. Considering this further information, even if the inventory 410 indicates there is a surplus of availability, a television provider may not want to reduce the price 420 because the viewer information indicates 430 that available advertising inventory should be sought after by selective advertisers seeking a specific, affluent market segment. Just as other suppliers who sell products to such a market segment might seek to be profitable by selling at a higher margin rather than selling in volume, television service providers might adopt a similar strategy.

It should be noted that in the preferred embodiment demographic and psychographic information are generalized forms of information. While the information might be gathered by surveying individual viewers or extracting historical viewing information from set-top boxes, viewer information 430 stored in the cells 240 (FIG. 2) represents a generalized view of the potential viewers that are reached by a particular channel at a particular daypart in a particular zone. Thus, in this embodiment the viewer information 240 is unlike some Internet advertising tools that rely on and respond to information related to individual users. For example, some Internet advertising management tools record e-mail addresses of users that have visited particular websites and then target that user with ads related to the content of the website visited. Similarly, some Internet advertising management tools exploit cookies stored on an individual's computer to determine the websites visited by that individual to devise relevant advertising content that might be directed to that individual. By contrast, embodiments of the present invention use generalized data and, thus, can be used in managing and directing advertising without intrusively delving into information that might be considered to be too personal by many persons.

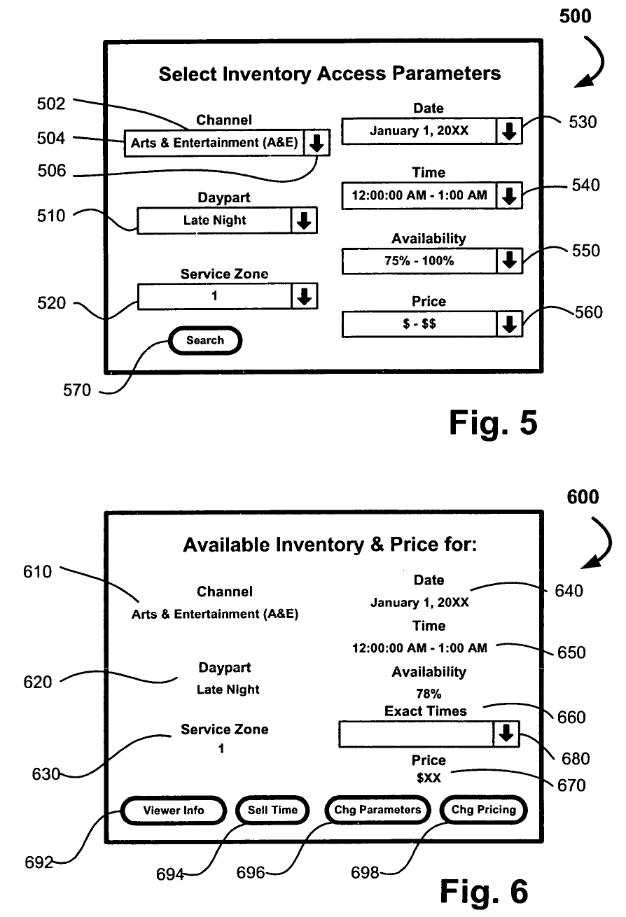

In one presently preferred embodiment of the invention, a computer-driven database is used to store and access information stored in the matrix 200 (FIG. 2). FIG. 5 is an access screen 500 from an interface for accessing the matrix 200 of FIG. 2. To evaluate advertising information including available inventory, pricing, and other information, the screen allows a user to isolate cells and information of interest. A channel field 502 allows a user to specify a channel of interest that might be listed in a channel field 504. The screen 500 suitably is menu-driven to provide a list of available channels, with the menu being accessible by clicking on a drop-down button 506, allowing the user to choose the channel by clicking on a list. Similarly, a user can choose a daypart from a daypart field 510 and a service zone form a service zone field 520. As will be appreciated from the foregoing description, a user may wish to specify different combinations from among the fields 502, 510, and 520.

As also shown on the screen 500, the matrix 200 (FIG. 2) also can be accessed by identifying more specific criteria. A user may wish to study advertising information related to a particular date by specifying that date in a date field 530. In addition to identifying a particular daypart, the user may wish to identify specific times of day in a time field 540. Also, the user may be interested only in studying advertising where a particular level of available inventory remains and can indicate that choice using an availability field 550. Alternatively, the user may be interested only in studying advertising priced at a particular price point and can indicate that choice using a price field 560. Using these fields, the user may, for example, choose to study how high-priced advertising time is selling. For another example, the user may wish to find out which advertising is selling poorly for purposes of deciding what advertising time to recommend to would-be advertisers or, possibly, for purposes of considering whether a price change would be appropriate. Once the user identifies all the particular criteria of interest to narrow the inquiry, the user can activate a search button 570 to retrieve the information of interest.

It should be noted that the access screen 500, or other access screens, can be configured to allow users to search on any type of information stored in the cells 240 of the matrix 200 (FIG. 2). If the viewer information is suitably structured, a user could search for income ranges, interests, or other information to determine what channels, dayparts, and zones reach an audience of interest for an advertiser seeking persons having those incomes or interests. The flexibility of the present invention is not restricted to configurations of embodiments shown on screen 500 or other screens.

Depending on the criteria specified, the user may be presented with different types of information. For example, FIG. 6 shows an inventory screen 600 specifying the availability and price of advertising for a particular channel 610, daypart 620, and service zone 630 on a particular date 640 and a particular time 650 also specified by the user at a screen 500 (FIG. 5). The screen 600 presents to the user the availability 660 of advertising for the specified criteria, and the current price 670 for the advertising. Based on the information retrieved and presented on the screen 600, the user might be interested in reviewing exactly what time slots have not been sold using an exact time field 680.

The user might seek viewer information for the cell represented by choosing the viewer information button 692. The user might want this information to market the available time to a would-be advertiser, or might want to see the information to decide if a price change is warranted. If the user is successful in marketing the time, the user might select a sell time button 694 to log the sold time. Once the time is sold, the inventory would be updated in the matrix, preferably in real time. If, in one presently preferred embodiment, the matrix is shared with other users, then those other users would also have access to up-to-date information about inventory and pricing for that cell. If the user is needs other information, the user might select the change parameters button 696 to revert to a selection screen 500 (FIG. 5) to specify other criteria for which the user wants advertising information.

Whether the user is marketing advertising time to a would-be advertiser or not, if there is excess inventory, the user may wish to change the pricing of the advertising inventory he or she is studying by selecting the change pricing button 698. The matrix 200 (FIG. 2) also could be configured to automatically update prices based on other information stored in the cells 240 of the matrix 200.

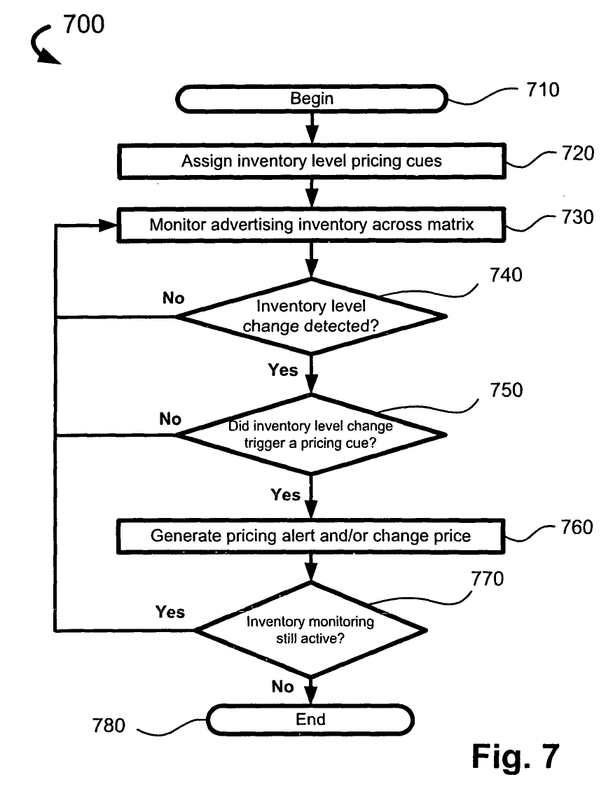

FIG. 7 is a flowchart of a routine 700 according for monitoring advertising inventory changes and adjusting pricing. The routine 700 begins at a block 710 at which inventory monitoring is initiated. At a block 720 inventory level pricing cues are set. For example, when advertising inventory for a particular segment of the matrix 200 (FIG. 2) drops to an availability of 10% or less, the matrix 200 can be configured to alert advertising personnel or automatically increase the price of that remaining inventory prices to a next higher preset rate or increase the price by a predetermined percentage. Similarly, if the inventory is 90% or more and the date of the availability is predetermined to be too close at hand to have so much inventory remaining, the matrix 200 can be configured to reduce the price to a predetermined rate or by a predetermined percentage. These price changes also can be programmed to respond to the viewer information stored in the relevant cells 240 (FIG. 2). If the prospective viewers associated with the advertising inventory are considered to be affluent, price reductions may not be implemented, although automatic price increases may be implemented. Many different automatic adjustments or permissible manual adjustments tied to inventory, pricing, or viewer information are possible. Thus, setting inventory level pricing cues at such levels supports effective management of advertising inventories.

Once the inventory level pricing cues are set at the block 720, at a block 730 advertising inventory is monitored across the matrix 200 (FIG. 2). At a decision block 740 it is determined if an inventory level change has been made by a user of the matrix 200. As long as no change is detected at the block 740, the routine 700 loops to the block 730 to continue monitoring for advertising inventory changes. On the other hand, if an advertising inventory level change is detected at the block 740, at a decision block 750 it is determined if the advertising inventory change triggers a pricing cue that was set at the block 720 such that a pricing change is appropriate. If it is determined at the block 750 that the advertising inventory change does not trigger a pricing cue, the routine 700 loops back to the block 730 to continue monitor advertising inventory levels across the matrix 200.

On the other hand, if an inventory level change is determined to trigger a pricing cue at the block 750, at the block 760 a pricing alert or pricing change is initiated. At election of the management, the matrix 200 (FIG. 2) can be programmed to alert the management when a pricing cue programmed at the block 720 is triggered, and the management can decide whether to make a pricing change. Alternatively, the matrix 200 can be programmed to automatically make a price change. In the example described previously, the matrix 200 may be programmed to apply a 10% price increase when available advertising inventory drops to 10%, or apply a 10% price reduction when available advertising inventory exceeds 90% within a certain time when the program in question will air. The matrix 200 can be programmed to both make a price change and generate a pricing alert to inform management of the change so that management will be kept aware of the inventory and pricing activity.

After pricing alerts and/or changes are effected at the block 760, at a decision block 770 it is determined if the inventory monitoring initiated at the block 710 is still active. If so, the routine 700 loops back to the block 730 to continue monitoring advertising inventory across the matrix. If not, for example if the management has elected to resume entirely manual control of the advertising inventory monitoring and pricing activity, the routine 700 ends at a block 780.

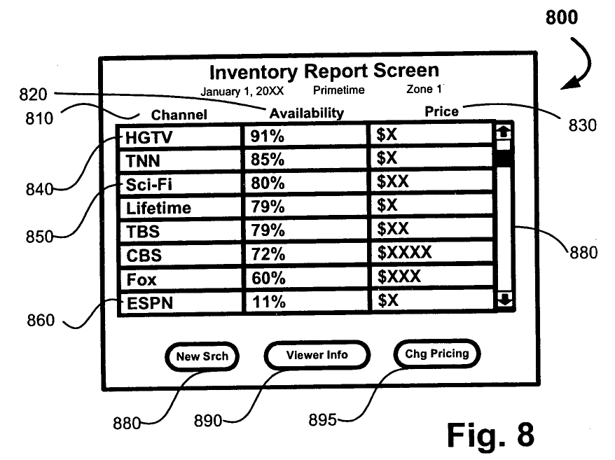

FIG. 8 shows an inventory sort screen 800 which might be presented to a user depending on the criteria specified by the user on the access screen 500 (FIG. 5). At the access screen 500 (FIG. 5), the user may have specified only a date, daypart, and zone of interest, while not specifying other criteria. The screen 800 presented thus presents channels 810, inventory availability 820, and pricing 830 for that date, daypart, and zone. Based on the user's selection (not shown) or automatically, the information may be sorted according to the information retrieved, and the user can navigate through available information by manipulating a scroll bar 870 or through other means.

On the screen 800, the channel 810, availability 820, and price information 830 is sorted according to descending available inventory. Thus, a user can see that a first channel 840 might have a high availability 820 at a low price 830. A user might also see that a second channel 850 might have a slightly lower availability 820 at a higher price 830. Advertising on both the first channel 840 and the second channel 850 might be candidates for price reductions to reduce available inventory. On the other hand, a third channel 860 might have a low availability 820 at a low price 830 and, therefore, be a prime candidate for a price increase.

In the case of any of the channels 840, 850, and 860, the user might want to highlight the channel of interest and select the viewer information button 890 for the channel of interest. As previously described, the user might want to consider available demographic or psychographic viewer information before making any price changes. The demographic of psychographic viewer information could be stored in or linked to the matrix 200 (FIG. 2) to enable a user to readily access the information. The information presented may include the size of the anticipated viewer population, breakdowns of gender or age, information about viewer interests and likely spending habits, or other information. Availability of such information advantageously provides decision support in managing the advertising inventory and related pricing structures.

If the user chooses to change the price 830 for a particular channel, the user can change the price 830 by selecting the change pricing button 895. If the user does not want to make changes for these channels, the user can select the new search button 880 to initiate a new query. In any case, the ability to compare the availability 820 and price 830 allows for informed, specific changes to be made to the prices currently set for the individual channels 810. The user can evaluate inventory and price, along with other viewer information that might properly inform such choices.

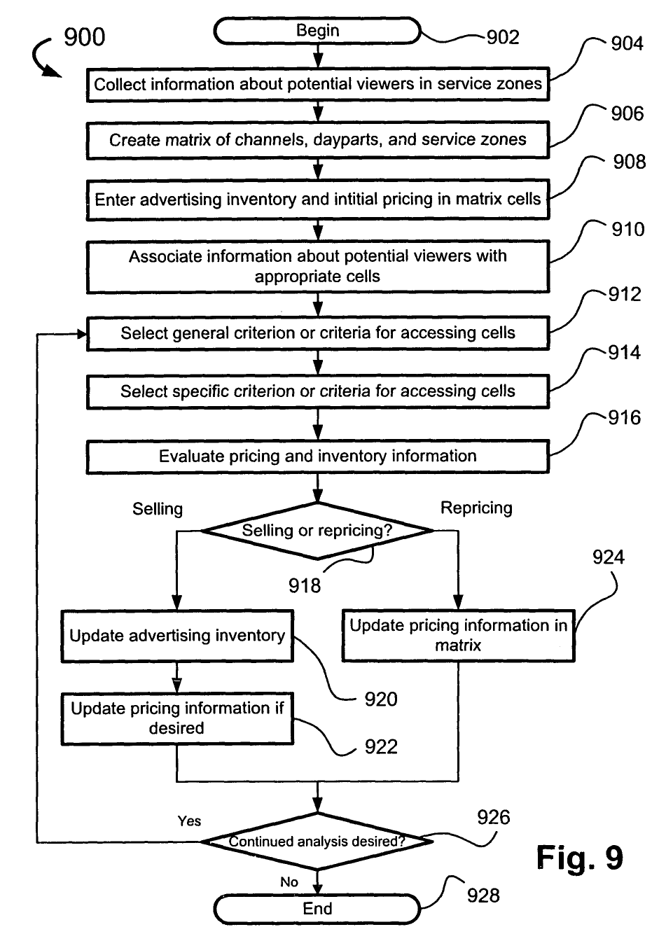

FIG. 9 is a flowchart of a routine 900 according to an embodiment of the present invention for creating and using such a matrix 200 (FIG. 2) to support advertising decision making. The routine 900 begins at a block 902. At a block 904 information is collected about potential viewers in service zones within the television provider's service area. At a block 906 a matrix 200 (FIG. 2) is created defined by channels, dayparts, and service zones. At a block 908 initial inventory of advertising and initial pricing of the advertising inventory is entered into the cells 240 (FIG. 2). At a block 910, viewer information about the potential viewers is stored in or associated with the cells 240 (FIG. 2). The matrix 200 (FIG. 2) is now ready for use. The matrix 200 (FIG. 2) can be created using application specific code or created using a database program such as Microsoft Access®.

Now that the matrix 200 (FIG. 2) is ready for use, at a block 912, criteria are selected for evaluating the advertising information. As described in connection with the access screen 500 (FIG. 5), the user can specify general parameters defining the information in which he or she is interested, such as channel, daypart, and zone. At a block 914, if desired, the user can specify more specific information of interest, such as dates, times of day, and other types of information described in connection with the access screen 500 (FIG. 5).

Once information of interest has been retrieved from the matrix 200 (FIG. 2), at a block 916 the user can evaluate pricing and inventory information as previously described. At a decision block 918, if it is determined that the user is accessing the matrix 200 (FIG. 2) to sell advertising time, the time is sold. At a block 920 the advertising inventory information is updated. At a block 922, pricing information, based on changes in inventory is also changed as desired, either automatically or manually as permitted as described previously in connection with FIG. 7. At the decision block 918, if it is determined that the user is accessing the matrix to re-price advertising, the pricing information is updated at a block 924.

At a decision block 926, it is determined if continued analysis of the advertising information is desired for selling, re-pricing, or other purposes. As long as continued analysis is desired, the routine 900 loops to the block 912 for selection of general criteria for accessing cells 240 of the matrix 200 (FIG. 2) to retrieve desired information. On the other hand, if it is determined at the decision block 926 that no further analysis is desired, the routine ends at a block 928.

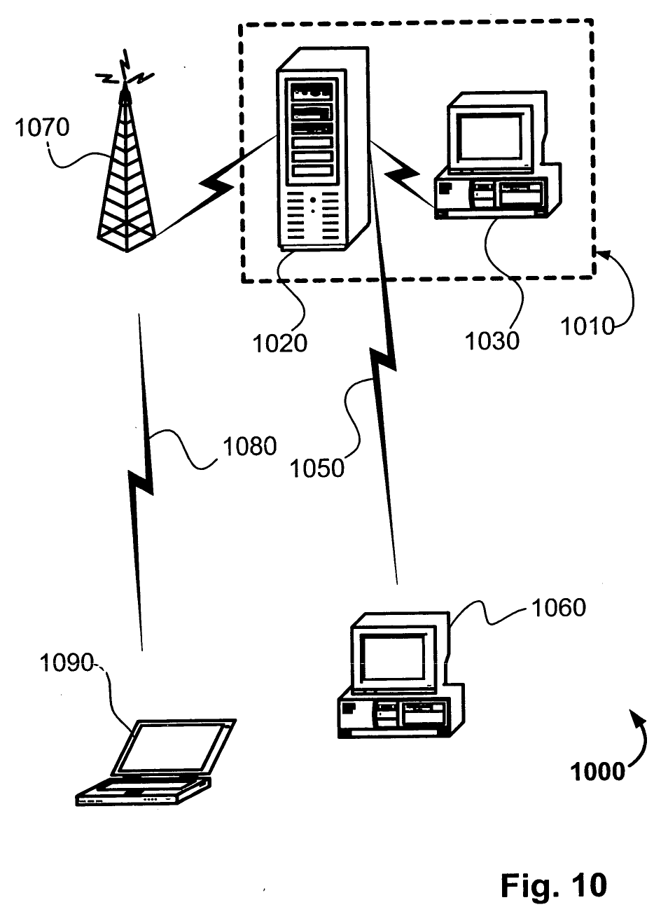

FIG. 10 is a system diagram of a multiple-user environment 1000 of the present invention. At an advertising sales office or in the information technology department of an organization selling advertising time 1010, the matrix 200 (FIG. 2) resides on a server 1020. A workstation 1030 suitably is used for creation and maintenance of the matrix 200, and also can be used by a user of the matrix to control advertising inventory and pricing information. It should be appreciated that the matrix 200 could reside on a single workstation in an environment the distributed access shown in the environment 1000 of FIG. 10 is not desired or preferred.

In the environment 1000, the server 1020 is operably coupled via a network link 1050 to a remote workstation 1060. The remote workstation 1060 allows an additional user to access the matrix 200 (FIG. 2) at the same time as a user accessing the matrix 200 at the workstation 1030, or at a location different from the workstation 1030. The network link 1050 could be a local area network connection, an Internet connection, or some other communications link. The server 1020 is also operably linked to a wireless network 1070 so that a wireless network link 1080 provides access to another remote user at a portable workstation 1090. Accordingly, multiple local or remote users can access advertising and pricing information.

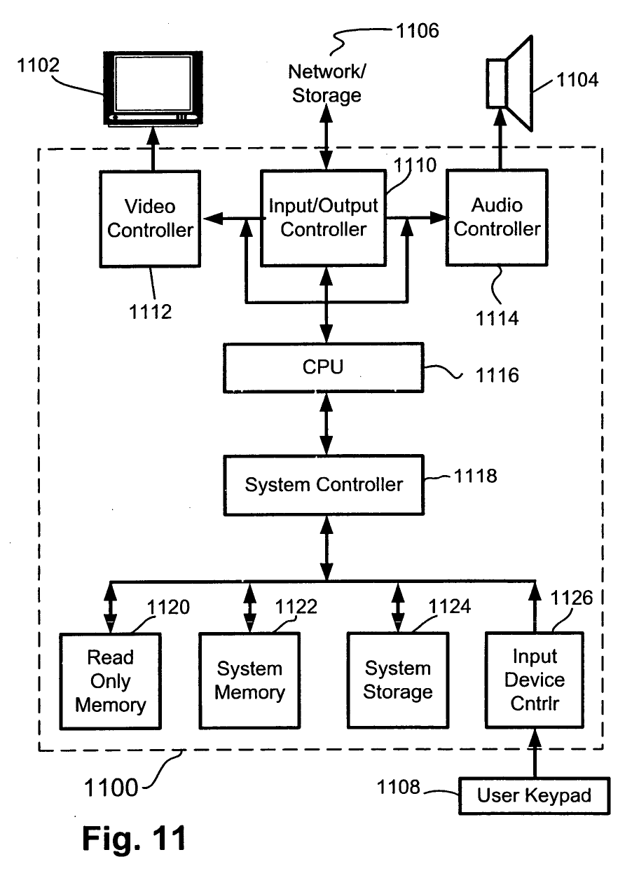

FIG. 11 is a computer system 1100 operable to support operation of a software embodiment of the present invention. The computer system 1100 supports operation of the matrix 200 (FIG. 2) for managing advertising inventory and pricing information. In one presently preferred embodiment, the computer system 1100 is a separate system from television advertising insertion system which would actually interface with a television broadcast system and insert advertisements into the broadcast data stream. However, in other embodiments, the computer system 1100 supporting operation of the software embodiment of the present invention may be networked or otherwise combined with the television advertising insertion system. Within the broad concepts of the present invention, the computer system 1100 also may be operably coupled with the traffic and billing systems of the television service provider which advantageously could facilitate collection of viewer information from set-top boxes.

The computer system 1100 represents a workstation on which the matrix 200 (FIG. 2) resides or from which the matrix 200 can be accessed. The computer system 1100 is operable for controlling a display 1102, such as a monitor, and an audio subsystem 1104, such as a stereo or a loudspeaker system through which audible inventory information could be audibly communicated. The computer system 1100 communicates information with a local area network or other network in a shared access environment, and/or with storage 1106. The computer system 1100 also receives user input from a wired or wireless user keypad 1108, which may be in the nature of a computer keyboard, or another input device.

The computer system 1100 receives input via an input/output controller 1110, which directs signals to and from a video controller 1112, an audio controller 1114, and a central processing unit (CPU) 1116. In turn, the CPU 1116 communicates through a system controller 1118 with input and storage devices such as read only memory (ROM) 1120, system memory 1122, system storage 1124, and input device controller 1126. While the user is accessing the matrix 200 (FIG. 2), an interface for engaging the interface can be loaded into system memory 1122. The matrix 200 can reside in the system storage 1124 in a single-user environment or on a network 1106 in a shared access environment.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for managing television advertising inventory and pricing in a service area, the method comprising:
classifying available advertising into a matrix including a plurality of cells storing advertising information, each of the cells being associated with a channel, a daypart, and a service zone within the service area;
associating with each cell an available advertising inventory,
associating with each cell relevant viewer information;
associating with each cell an advertising price settable based on the available advertising inventory and the relevant viewer information; and
accessing one of the available advertising inventory information and the pricing information stored in the matrix by specifying at least one selection criterion reflective of the advertising information stored in the plurality of cells.

2. The method of claim 1, wherein the service zones associated with the cells are delineated geographically.

3. The method of claim 1, wherein the service zones associated with the cells are delineated according to other information aligning persons into an identifiable group.

4. The method of claim 1, further comprising populating the cells of the matrix with relevant viewer information regarding potential television viewers in the service zones associated with the cells.

5. The method of claim 4, wherein the viewer information is gathered from surveys of the potential television viewers in the services zones.

6. The method of claim 4, wherein the viewer information is gathered by extracting viewer information from set-top boxes configured to relay television content from a television service provider in the service zones.

7. The method of claim 1, wherein the viewer information includes psychographic information.

8. The method of claim 7, wherein the psychographic information includes at least one of viewer income, viewer spending preferences, viewer interests, viewer politics, and viewer television viewing habits.

9. The method of claim 1, wherein the viewer information includes demographic information.

10. The method of claim 9, wherein the demographic information includes one of viewer age, viewer gender, and viewer residence information.

11. The method of claim 1, wherein the available advertising inventory includes specific timing and duration information regarding when available advertising inventory exists.

12. The method of claim 1, further comprising automatically updating the available advertising inventory to reflect sales of advertising slots.

13. The method of claim 1, further comprising at least one of generating a pricing alert as function of the available advertising inventory and automatically adjusting the pricing information as a function of the available advertising inventory.

14. The method of claim 1, wherein the selection criterion for accessing the available inventory information includes choosing at least one of the channel, the daypart, and the service zone.

15. The method of claim 14, wherein the selection criterion for accessing the available advertising inventory information includes at least one of availability, unit price, demographic information, and psychographic information.

16. The method of claim 15, further comprising sorting the available advertising inventory according to at least one of the availability, the unit price, the demographic information, and the psychographic information.

17. The method of claim 1, further comprising providing shared access to the matrix such that a plurality of users have the ability to current inventory information and pricing information.

18. A method for managing television advertising inventory and pricing in a service area, the method comprising:
classifying available advertising into a matrix including a plurality of cells storing advertising information, each of the cells being associated with a channel, a daypart, and a service zone within the service area;
associating with each cell an available advertising inventory,
populating the cells of the matrix with psychographic information regarding potential television viewers in the service area, the psychographic information being gathered from one of surveys of at least a subset of the potential television viewers and set-top boxes configured to relay television content from a television service provider;
associating with each cell an advertising price settable based on the available advertising inventory and the psychographic information; and
accessing one of the available advertising inventory information and the pricing information the matrix by specifying at least one selection criterion reflective of the advertising information stored in the plurality of cells.

19. The method of claim 18, wherein the service zones associated with the cells are delineated geographically.

20. The method of claim 18, wherein the service zones associated with the cells are delineated according to other information aligning persons into an identifiable group.

21. The method of claim 18, wherein the psychographic information includes at least one of viewer income, viewer spending preferences, viewer interests, viewer politics, and viewer television viewing habits.

22. The method of claim 18, further comprising demographic information associated with the cells of the matrix.

23. The method of claim 22, wherein the demographic information includes one of viewer age, viewer gender, and viewer residence information.

24. The method of claim 18, wherein the available advertising inventory includes specific timing and duration information regarding when available advertising inventory exists.

25. The method of claim 18, further comprising at least one of generating a pricing alert as function of the available advertising inventory and automatically adjusting the pricing information as a function of the available advertising inventory.

26. The method of claim 18, further comprising automatically adjusting the pricing information as a function of the available advertising inventory.

27. The method of claim 18, wherein the selection criterion for accessing the available inventory information includes choosing at least one of the channel, the daypart, and the service zone.

28. The method of claim 27, wherein the selection criterion for accessing the available advertising inventory information includes at least one of availability, unit price, demographic information, and psychographic information.

29. The method of claim 28, further comprising sorting the available advertising inventory according to at least one of the availability, the unit price, the demographic information, and the psychographic information.

30. The method of claim 18, further comprising providing shared access to the matrix such that a plurality of users have the ability to current inventory information and pricing information.

31. A computer-readable medium having stored thereon instructions for controlling operations of a computer for managing television advertising inventory and pricing in a service area, the computer-readable medium comprising:
first computer program code means for classifying available advertising into a matrix including a plurality of cells storing advertising information, each of the cells being associated with a channel, a daypart, and a service zone within the service area;
second computer program code means for associating with each cell an available advertising inventory,
third computer program code means for associating with each cell relevant viewer information;
fourth computer program code means for associating with each cell an advertising price settable based on the available advertising inventory and the relevant viewer information; and
fifth computer program code means for accessing one of the available advertising inventory information and the pricing information stored in the matrix by specifying at least one selection criterion reflective of the advertising information stored in the plurality of cells.

32. The computer-readable medium of claim 31, wherein the service zones associated with the cells are delineated geographically.

33. The computer-readable medium of claim 31, wherein the service zones associated with the cells are delineated according to other information aligning persons into an identifiable group.

34. The computer-readable medium of claim 31, further comprising sixth computer program code means for populating the cells of the matrix with relevant viewer information regarding potential television viewers in the service zones associated with the cells.

35. The computer-readable medium of claim 34, wherein the viewer information is gathered from surveys of the potential television viewers in the services zones.

36. The computer-readable medium of claim 34, wherein the viewer information is gathered by extracting viewer information from set-top boxes configured to relay television content from a television service provider in the service zones.

37. The computer-readable medium of claim 31, wherein the viewer information includes demographic information.

38. The computer-readable medium of claim 31, wherein the demographic information includes one of viewer age, viewer gender, and viewer residence information.

39. The computer-readable medium of claim 31, wherein the viewer information includes psychographic information.

40. The computer-readable medium of claim 39, wherein the psychographic information includes at least one of viewer income, viewer spending preferences, viewer interests, viewer politics, and viewer television viewing habits.

41. The computer-readable medium of claim 31, wherein the available advertising inventory includes specific timing and duration information regarding when available advertising inventory exists.

42. The computer-readable medium of claim 31, further comprising eighth computer program code means for automatically updating the available advertising inventory to reflect sales of advertising slots.

43. The computer-readable medium of claim 31, further comprising ninth computer program code means for at least one of generating a pricing alert as function of the available advertising inventory and automatically adjusting the pricing information as a function of the available advertising inventory.

44. The computer-readable medium of claim 31, wherein the selection criterion for accessing the available inventory information includes choosing at least one of the channel, the daypart, and the service zone.

45. The computer-readable medium of claim 44, wherein the selection criterion for accessing the available advertising inventory information includes at least one of availability, unit price, demographic information, and psychographic information.

46. The computer-readable medium of claim 46, further comprising tenth computer program code means for sorting the available advertising inventory according to at least one of the availability, the unit price, the demographic information, and the psychographic information.

47. The computer-readable medium of claim 31, further comprising eleventh computer program code means for providing shared access to the matrix such that a plurality of users have the ability to current inventory information and pricing information.

48. A system for managing television advertising inventory and pricing in a service area, the system comprising:
a computer system comprising:
a processor;
an input device, operably connected to the processor, allowing data to be entered into the computer system;
an output device, operably connected to the processor, allowing data to be output from the computer system;
a system memory operably connected to the processor; and
at least one storage device operably coupled with the computer system, the storage device being configured to store software and data; and
a software system comprising:
a classifier configured to classify available advertising into a matrix including a plurality of cells storing advertising information, each of the cells being associated with a channel, a daypart, and a service zone within the service area;
an associator configured to associate with each cell an available advertising inventory, relevant viewer information, and a price settable based on the available advertising inventory and the relevant viewer information; and
an interface configured to access one of the available advertising inventory information and the pricing information stored in the matrix by specifying at least one selection criterion reflective of the advertising information stored in the plurality of cells.

49. The system of claim 48, wherein the service zones associated with the cells are delineated geographically.

50. The system of claim 48, wherein the service zones associated with the cells are delineated according to other information aligning persons into an identifiable group.

51. The system of claim 48, further comprising a cell populator configured to populate the cells of the matrix with relevant viewer information regarding potential television viewers in the service zones associated with the cells.

52. The system of claim 51, wherein the viewer information is gathered from surveys of the potential television viewers in the services zones.

53. The system of claim 51, wherein the viewer information is gathered by extracting viewer information from set-top boxes configured to relay television content from a television service provider in the service zones.

54. The system of claim 48, wherein the viewer information includes psychographic information.

55. The system of claim 54, wherein the psychographic information includes at least one of viewer income, viewer spending preferences, viewer interests, viewer politics, and viewer television viewing habits.

56. The system of claim 48, wherein the viewer information includes demographic information.

57. The system of claim 56, wherein the demographic information includes one of viewer age, viewer gender, and viewer residence information.

58. The system of claim 48, wherein the available advertising inventory includes specific timing and duration information regarding when available advertising inventory exists.

59. The system of claim 48, further comprising an updater configured to automatically update the available advertising inventory to reflect sales of advertising slots.

60. The system of claim 48, further comprising a price analyzer configured to at least one of generate a pricing alert as function of the available advertising inventory and automatically adjust the pricing information as a function of the available advertising inventory.

61. The system of claim 48, wherein the selection criterion for accessing the available inventory information includes choosing at least one of the channel, the daypart, and the service zone.

62. The system of claim 61, wherein the selection criterion for accessing the available advertising inventory information includes at least one of availability, unit price, demographic information, and psychographic information.

63. The system of claim 62, further comprising a sorter configured to sort the available advertising inventory according to at least one of the availability, the unit price, the demographic information, and the psychographic information.

64. The system of claim 1, further comprising providing shared network access to the matrix such that a plurality of users have the ability to current inventory information and pricing information.
